(19) United States
(12) Patent Application Publication
(10) Pub. No.: US 2026/0319756 A1
(43) Pub. Date: Oct. 15, 2026

(54) FORMAL SPECIFICATION ASSISTED PROGRAM REPAIR

(71) Applicant: Oracle International Corporation, Redwood Shores, CA (US)

(72) Inventors: Yuntong ZHANG, Queenstown (SG); Mahinthan CHANDRAMOHAN, Brisbane (AU); Padmanabhan KRISHNAN, Brisbane (AU)

(73) Assignee: Oracle International Corporation, Redwood Shores, CA (US)

(21) Appl. No.: 19/178,823

(22) Filed: Apr. 14, 2025

(51) Int. Cl. G06F 8/30

(52) U.S. Cl. CPC G06F 8/30

(57) ABSTRACT

A method implements formal specification assisted program repair. The method involves processing buggy code to generate a specification from the buggy code using a specification generation prompt. The method further involves verifying the specification to generate a verified specification. The method further involves injecting the verified specification into a repair prompt. The method further involves generating a candidate patch for a buggy method in the buggy code using the repair prompt.

### BACKGROUND

Software developers spend a significant amount of time maintaining existing software and fixing bugs (including security vulnerabilities) in them. To reduce the manual effort in bug fixing, various Automated Program Repair (APR) techniques (referred to as automated repair) may be used. Automated repair may be used as a part of test-driven automated repair, where a buggy program and one or more failing tests that illustrate the bug in the buggy program are provided. An automated repair system is designed to output candidate patches that resolve the failing tests and fix the bug.

With the emergence of large language models (LLMs, referred to as language models), language model based automated repair techniques may be used to repair buggy programs. The repair task may be accomplished by performing a repair conversation with a backend language model. Challenges emerge when using language models for automated repair due to over reliance on failing tests and from error messages that may be ad hoc or written informally that do not capture the repair to be made to the buggy code.

### SUMMARY

In general, in one or more aspects, the disclosure relates to a method for formal specification assisted program repair. The method involves processing buggy code to generate a specification from the buggy code using a specification generation prompt. The method further involves verifying the specification to generate a verified specification. The method further involves injecting the verified specification into a repair prompt. The method further involves generating a candidate patch for a buggy method in the buggy code using the repair prompt.

In general, in one or more aspects, the disclosure relates to a system that includes at least one processor and an application that executes on the at least one processor. Executing the application performs processing buggy code to generate a specification from the buggy code using a specification generation prompt. Executing the application further performs verifying the specification to generate a verified specification. Executing the application further performs injecting the verified specification into a repair prompt. Executing the application further performs generating a candidate patch for a buggy method in the buggy code using the repair prompt.

In general, in one or more aspects, the disclosure relates to a non-transitory computer readable medium including instructions executable by at least one processor. Executing the instructions performs processing buggy code to generate a specification from the buggy code using a specification generation prompt. Executing the instructions further performs verifying the specification to generate a verified specification. Executing the instructions further performs injecting the verified specification into a repair prompt. Executing the instructions further performs generating a candidate patch for a buggy method in the buggy code using the repair prompt.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, FIG. 6, FIG. 7, and FIG. 8 show examples in accordance with the disclosure.

FIG. 9.1 and FIG. 9.2 show computing systems in accordance with the disclosure.

Similar elements in the various figures may be denoted by similar names and reference numerals. The details of the features and elements described in one figure may extend to similarly named features and elements in different figures.

### DETAILED DESCRIPTION

A language model based program repair workflow is assisted by auto-generated formal specifications. Instead of relying on the failing tests to indicate the direction of repair, the language model and a verification engine are utilized to automatically generate formal specifications that capture the repair goal. Given the buggy code and the failing tests, a backend language model is instructed to generate a specification that captures the intended behavior of the program to fix the issues (one or more bugs) within the buggy code. An improvement comes from performing specification refinement using a combination of a language model and a verification engine. After the initial specification is generated, the specification is validated using the verification engine, and the verification output may be sent back to the language model for iterative improvement of the generated specification based on errors in the verification output. The final auto-generated specification may then be used as a formal description of the goal for future program repair.

With the auto-generated specification for a bug, the next step is to use the specification to assist language model-based program repair tools for fixing the bug. The specification is integrated as part of the instructions to the language model when generating candidate patches. In generating the candidate patches, the language model is instructed to generate candidate patches that follow the specification. Utilizing the specification guides the language model to generate candidate patches with a formal and concise goal and reduces the likelihood of additional issues being generated by code that does not conform to the specification.

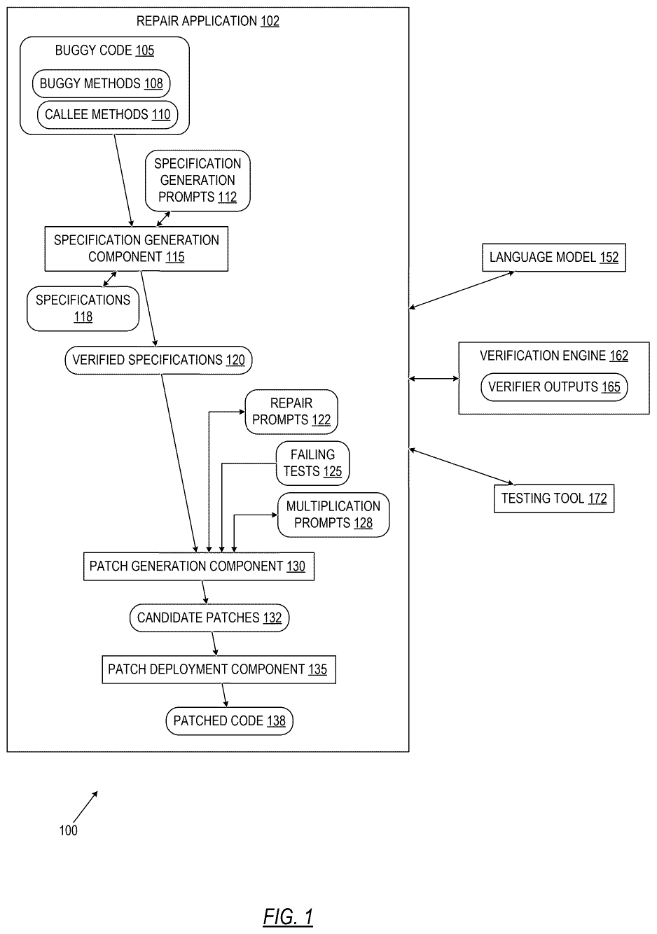

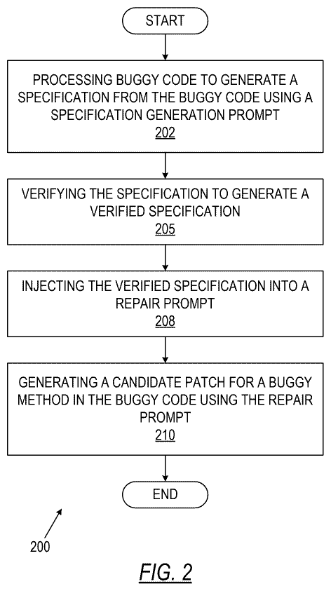

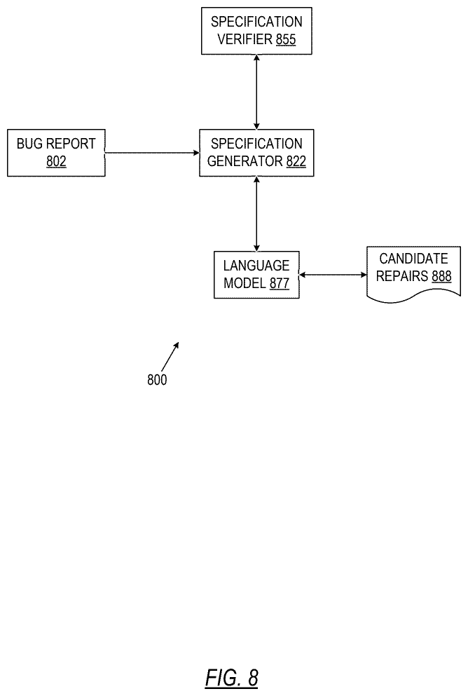

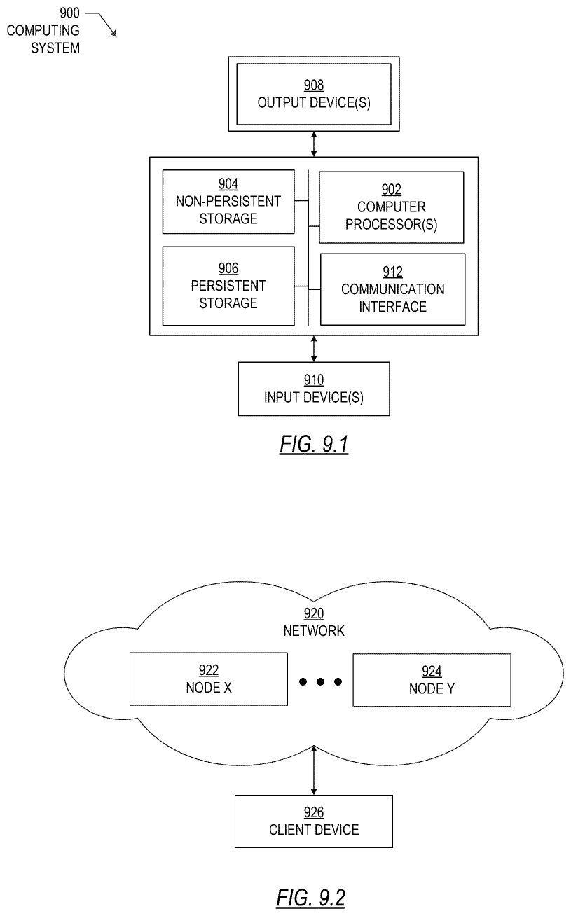

Turning to FIG. 1, the system (100) includes components of one or more computing systems implementing formal specification assisted program repair. The components of the system (100) may each include hardware and software components that may be implemented as part of the computing systems described in the other figures, including those of FIG. 9.1 and FIG. 9.2. The system (100) includes the repair application (102), the language model (152), the verification engine (162), and the testing tool (172).

The repair application (102) is a component of the system (100) that generates the patched code (138) from the buggy code (105). The repair application (102) communicates with the language model (152), the verification engine (162), and the testing tool (172) to process the buggy code (105) and generate the patched code (138). The repair application (102) includes the specification generation component (115), the patch generation component (130), and the patch deployment component (135).

The buggy code (105) is software code that contains errors or defects (referred to as bugs), resulting in unintended or incorrect behavior during execution. The buggy code (105) may be stored in one or more electronic files. The buggy code (105) may be part of a codebase that is a collection of software code, related files, and documentation that form a software project. Software code is a set of instructions written in a programming language that instructs a computer to perform a specific task. A programming language is a formal language designed to communicate instructions to a computer and used to create software. Examples of programming languages include Java, Python, C++, etc. A formal language is a set of strings of symbols that adhere to a defined set of rules to eliminate ambiguity in interpretation. The buggy code (105) includes the buggy methods (108) and the callee methods (110).

The buggy methods (108) are methods within the buggy code (105) that have been identified as having a bug. A method is a named block of code within the buggy code (105), which may perform a specific task or operation. The buggy method (108) may be identified in a bug report. A bug report is a document (e.g., a text file) that describes a software defect (a bug). The bug report may include descriptions of the symptoms, steps to reproduce, and expected versus actual behavior for a bug in one of the buggy methods (108).

The callee methods (110) are called by the buggy methods (108). The callee methods (110) may be internal or external to the buggy code (105).

The specification generation prompts (112) are prompts for the language model (152) to generate the specifications (118). A prompt is the input provided to the language model (152) to instruct the language model (152) to generate a specific type of response as output from the language model (152). A prompt may include instructions, input text, example outputs, etc. The instructions may direct the language model (150) to generate a response from the input text that conforms with the example output. The input text is text used by the language model (150) to generate an output. The example outputs may be pairs of buggy code samples and repaired code samples as examples of the code to generate in a candidate patch for a buggy method. Different prompts may use different types of input text. For example, the specification generation prompts (112) may include one or more of the buggy code (105), the buggy methods (108), the callee methods (110), etc. as input text. As another example, the repair prompts (122) may include the verified specifications (120) as input text.

The specification generation prompts (112) may be dynamically generated to include several types of information. A specification generation prompt may include the name of one of the buggy methods (108) and the names of the calling methods (110) that are called by the buggy method. A specification generation prompt may also include a previous version of a specification generated by the language model (152) with corresponding verification output from the verification engine (162) for the previous version of the specification. A specification generation prompt may also include instructions with example outputs that direct the language model (152) to generate a specification (e.g., one of the specifications (118)) for the buggy code (105). One of the specification generation prompts (112) may be used to generate one of the specifications (118). The specification generation prompts (112) may also include specification refinement prompts to iteratively refine the specifications (118).

The specification generation component (115) is a component of the repair application (102). The specification generation component (115) generates the specification generation prompts (112) and utilizes the specification generation prompts (112) to generate the specifications (118). The specification generation component (115) may access the language to model (152) to generate the specifications (118) from the specification generation prompts (112). The specification generation component (115) may process the specifications (118) using the verification engine (162) to generate the verification outputs (165).

The specifications (118) are specifications for the buggy code (105). A specification (also referred to as a formal specification) is a description of the intended behavior of a program element, expressed through preconditions, postconditions, and invariants. A specification may include the underlying source code annotated with comments that specify the preconditions, postconditions, and invariants for different portions of the source code. A precondition is a condition that is true before a method or operation is executed. A postcondition is a condition that is true after a method or operation has successfully executed. An invariant is a condition that is true for an object or data structure throughout the lifetime of the object or data structure. The specifications (118) may be in accordance with a modeling language, examples of which include Java modeling language (JML).

The verified specifications (120) are a subset of the specifications (118). The verified specifications (120) have been verified using the verification engine (162). For one of the buggy methods (108), multiple specifications may be generated and refined until a specification passes verification and is identified as one of the verified specifications (120).

The repair prompts (122) are prompts for the language model (152) to generate the candidate patches (132). The repair prompts (122) may be dynamically generated to include several types of information. A repair prompt may include one of the verified specifications (120) and the buggy code (105) as well as instructions with example outputs. The instructions with example outputs in the repair prompts (122) direct the language model (152) to generate a candidate patch (e.g., one of the candidate patches (132)) for the buggy code (105). One of the repair prompts (122) may correspond to one of the buggy methods (108). A previous repair prompt may be revised and refined if the candidate patch generated from the previous repair prompt does not pass the tests (which may include the failing tests (125)) administered by testing tool (172).

The failing tests (125) are tests for the buggy code (105) that may be administered by the testing tool (172). A failing test (i.e., one of the failing tests (125)) is a test case that produces an unexpected or incorrect result, indicating a defect in the buggy code (105). A test case is a set of inputs, execution conditions, and expected results used to determine that software code is operating as expected. At least one of the failing tests (125) may correspond to one of the buggy methods (108). Executing a failing test with the corresponding buggy method produces a failure result indicating that the buggy method is not operating as expected.

The multiplication prompts (128) are prompts for the language model (152) to generate, from one of the candidate patches (132), additional candidate patches. A multiplication prompt (e.g., one of the multiplication prompts (128)) may be executed for a candidate patch after the candidate patch passes tests administered by the testing tool (172).

The patch generation component (130) is a component of the repair application (102). The patch generation component (130) generates the repair prompts (122) and the multiplication prompts (128) to generate the candidate patches (132). The patch generation component (130) may access the language model (152) to generate the candidate patches (132) from the repair prompts (122) and the multiplication prompts (128). The patch generation component (130) may access the testing tool (172) to administer the failing tests (125) to the candidate patches (132).

The candidate patches (132) are modifications to the buggy code (105) that may fix the bugs within the buggy code (105). One of the candidate patches (132) may be generated for one or more of the buggy methods (108). One of the candidate patches (132) may include modifications to multiple files of the buggy code (105).

The patched deployment component (135) is a component of the repair application (102). The patched deployment component (135) generates the patched code (138) by selecting and applying one or more of the candidate patches (132) to the buggy code (105). The patched deployment component (135) may also deploy the patched code (138) to another computing system for execution.

The patched code (138) is a version of the buggy code (105). The patched code (138) includes the modifications from one or more of the candidate patches (132).

The language model (152) processes a natural language input (e.g., a prompt) to generate a natural language output (e.g., a response) based on the contents of the natural language input. The natural language input and the natural language output may be in the form of text, tokens, embedding vectors, etc. The text may be a sequence of characters, words, or symbols forming a unit of written language. The tokens are values that represent discrete units of the text such as words, subwords, characters, etc. A token may be represented by an integer value. The embedding vectors are numerical representations of the tokens that represent the semantic meaning of the tokens and underlying text. An embedding vector may be represented by a set of floating point values with one embedding vector corresponding to one token, which may correspond to one word, subword, character, etc., from the text. The language model (152) may use one or more neural network models to process the natural language input to generate the natural language output.

The verification engine (162) is a component that verifies the specifications (118). The verification engine (162) may identify syntactical errors in a specification. The verification engine (162) may execute the buggy code (105) to identify errors in the execution of the buggy code (105) in violation of a specification. The verification engine (162) may process the specifications and may execute the buggy code (105) to generate the verification outputs (165).

The verification outputs (165) are the outputs from the verification engine (162). The verification outputs (165) may identify errors in the specifications (118), which may be syntax errors. The verification outputs (165) may also identify errors in the execution of the buggy code (105) in which the buggy code (105) does not execute in compliance with one or more of the specifications (118).

The testing tool (172) is a component that tests the buggy code (105) with the candidate patches (132). The testing tool (172) may test the candidate patches (132) with the failing tests (125).

FIG. 2 shows a flowchart of a method implementing methods and systems implementing formal specification assisted program repair. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) generates candidate patches to implement formal specification assisted program repair. The process (200) may include multiple steps (e.g., Block 202 through Block 212) that may execute on the components described in the other figures, including those of FIG. 1, FIG. 9.1, FIG. and 9.2.

Block 202 includes processing buggy code to generate a specification from the buggy code using a specification generation prompt. To generate the specification from the buggy code, a specification generation prompt may be dynamically generated that includes at least a portion of the buggy code (e.g., a buggy method), instructions, and example outputs. The specification generation prompt is input to a language model that processes the specification generation prompt to produce a response. The response is received from the language model and includes a specification for the buggy code as directed by the instructions in the specification generation prompt.

Processing the buggy code to construct the specification generation prompt may include retrieving callee methods called by the buggy method in the buggy code. With a buggy method identified from the buggy code, a static analysis tool may be used to identify the methods (the callee methods) that are called by the buggy method in the buggy code.

Processing the buggy code to construct the specification generation prompt may include constructing the specification generation prompt for the buggy method in the buggy code using the callee methods. The names of the callee methods identified for the buggy method, as well as the code for the callee methods, may be included in the specification generation prompt.

Block 205 includes verifying the specification to generate a verified specification. A verification engine may be accessed to verify the specification. Verification of the specification may process the specification to determine if the specification includes syntax errors. The syntax errors, if any, may be described in the verification output of the verification engine. If there are no syntax errors, the buggy code may be executed to determine if the execution of the buggy code is in conformance with the specification. Execution of the buggy code conforms to the specification when the preconditions, postconditions, and invariants defined in the specification are met during the execution of the buggy code. When execution does not conform to the specification, the lack of conformance, referred to as conformance errors, is described in the verification output from the verification engine. When no errors are identified with the specification, the specification may be identified as a verified specification.

Verifying the specification may include refining the specification using a verification output from a verification engine. The specification is refined based on errors identified in the verification output. The errors may include syntax errors or conformance errors. The specification generation prompt used to generate the specification may be refined to include the verification output. The specification generation prompt used to generate the specification may also be refined to include the specification, which may be used by the language model to create a refined version of the specification. The refined version of the specification may include updates to the preconditions, postconditions, and invariants of the specification to reduce the errors (syntax or conformance errors). The refined specification may be verified with the verification engine to be identified as a verified specification.

Block 208 includes injecting the verified specification into a repair prompt. The specification (or portions thereof) may be copied into a section of the repair prompt. The portions of the specification that relate to the buggy method may be copied into and may be identified with tags within the repair prompt.

Block 210 includes generating a candidate patch for a buggy method in the buggy code using the repair prompt. The candidate patch may be generated by inputting the repair prompt to the language model. The language model processes the repair prompt to generate the candidate patch that may be returned in a response. The response with the candidate patch is received from the language model.

Generating the candidate patch may include testing the candidate patch with a failing test. To test the candidate patch with the failing test, which may be one of many tests administered to the candidate patch, the candidate patch is applied to the original codebase, i.e., to the buggy code, to generate a patched codebase. The patched codebase is then compiled to generate compiled code for testing. The failing test is then executed against the compiled code to generate a test result. The test result indicates if the candidate patch (i.e., the compiled code) passes “failing test”. Finally, the test result is checked for a pass or fail. If the test result indicates the test is passed, the patch is tagged as successfully passing the failing test. Otherwise, the patch is tagged as still failing the failing test.

Generating the candidate patch may include revising the candidate patch after testing the candidate patch with a failing test. Following the initial testing of a candidate patch with a failing test, a revision process may be initiated. The repair prompt used to generate the candidate patch may be updated to include the one or more of the candidate patch and the test result from the failing test. The updated repair prompt may then be fed back to the language model to revise the candidate patch with adjustments made to the code intended to address the issues from the test result. The revised candidate patch is then applied to the buggy code to generate an updated version of the patched codebase. The patched codebase is then subjected to recompilation to generate a new compiled version for subsequent testing. The failing test, along with any other relevant tests, may be re-executed against this newly compiled version for the revised candidate patch. The test results are then re-evaluated. If the revised candidate patch now passes the failing test, and any other tests, then the revised candidate may be tagged as successful. If failures persist, the analysis and revision process may be repeated, iterating until the patch successfully resolves the defect without introducing new regressions. The number of iterations may be capped, e.g., 10 iterations.

Generating the candidate patch may include constructing a multiplication prompt using the candidate patch. The multiplication prompt may be constructed by collecting the buggy code and one or more candidate patches into the multiplication prompt. The buggy code and the candidate patches are included with instructions within the multiplication prompt to generate additional patches based on the candidate patches within the multiplication prompt, i.e., to multiply the candidate patches.

Generating the candidate patch may include multiplying the patch with a multiplication prompt to generate a plurality of candidate patches comprising the candidate patch. The multiplication prompt, including at least the candidate patch, is input to the language model. The language model processes the multiplication prompt to generate at least one alternative patch based on the multiplication prompt. Multiple alternative patches may be generated for each candidate patch from the multiplication prompt.

Generating the candidate patch may include selecting the candidate patch from a plurality of candidate patches. The candidate patch may be selected manually or automatically. A manual selection may be received through a user interface from a user. Automatic selection may be based on a heuristic. As an example, the patch with the fewest modifications to the buggy code may be selected. Different heuristics may be used.

The process (200) may further include applying the candidate patch to the buggy code to generate patched code. To apply the candidate patch, the modifications within the candidate patch are integrated into the corresponding locations within the buggy code.

The process (200) may further include deploying patched code generated from the candidate patch to a computing system. The computing system may execute the patched code. When executed, the patched code may perform as expected without the one or more bugs that were identified in the buggy code.

To deploy patched code generated from a candidate patch to a computing system, the computing system for deployment of the patched code is identified. The patched code may be transferred to the identified computing system. The transfer may involve copying files, using version control systems, using deployment tools, etc. The patched code may be compiled (if not already in compiled form) to generate executable binaries or interpreted code. An execution environment may be configured on the deployment computing system by setting environment variables, installing dependencies, allocating resources, etc. The patched code, in executable form, is initiated on the computing system. During execution, the computing system processes the instructions contained within the patched code to the operations specified in the patched code. The output and behavior of the executed patched code may be monitored to verify that the modifications identified in the candidate patch have been successfully deployed.

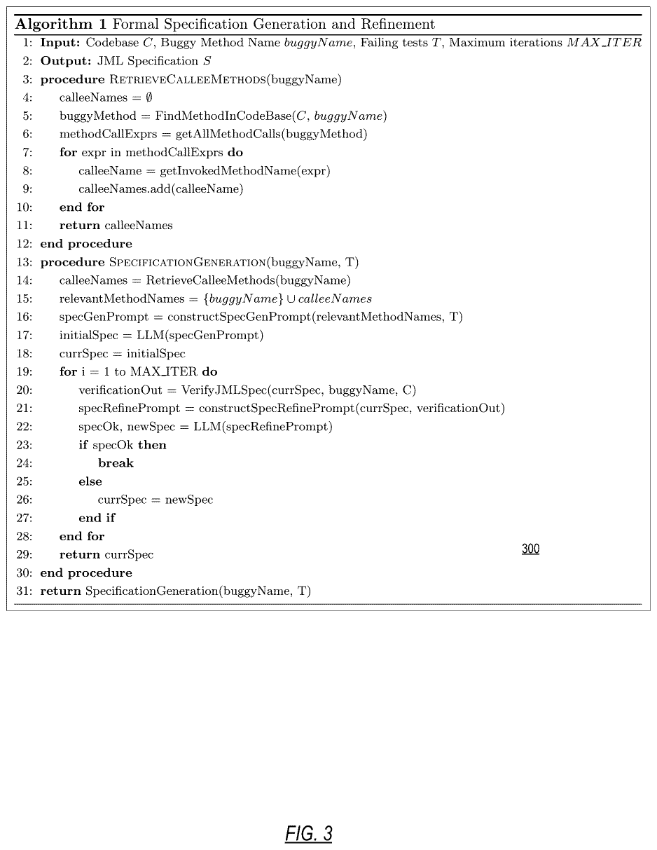

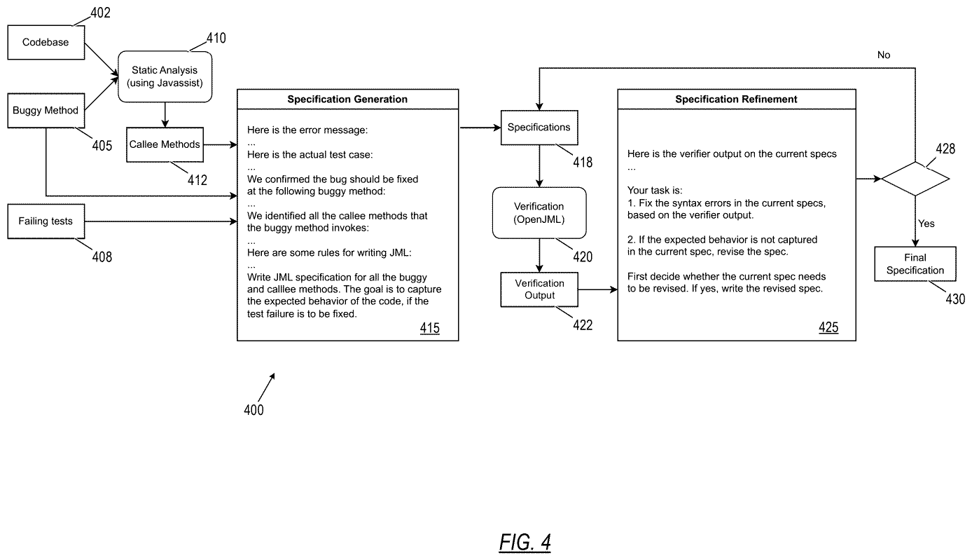

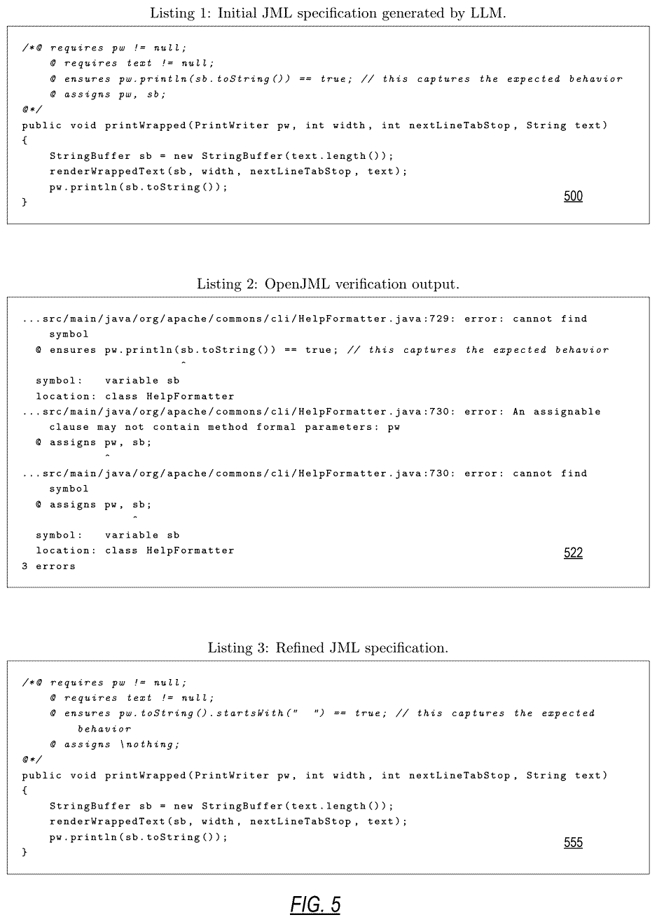

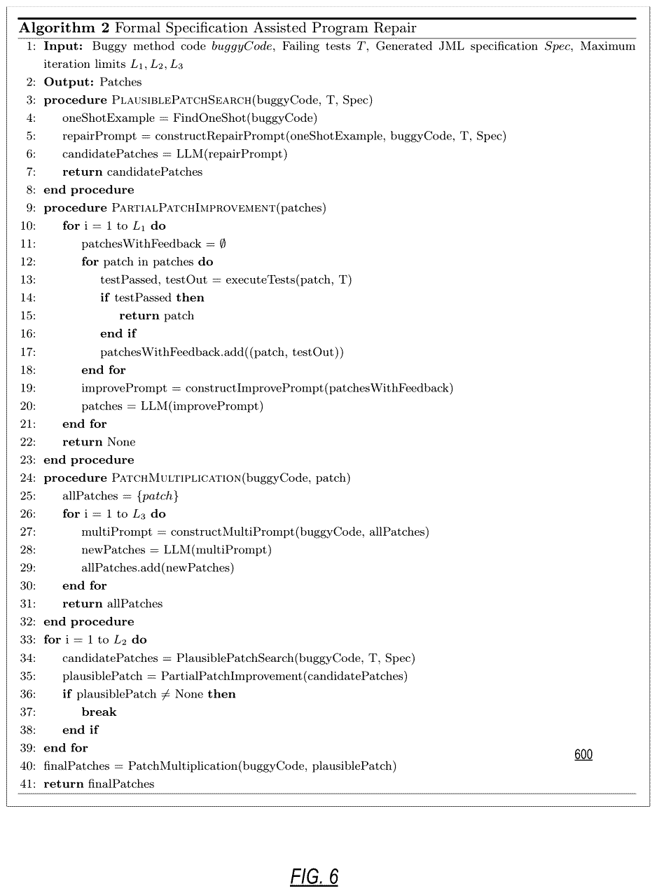

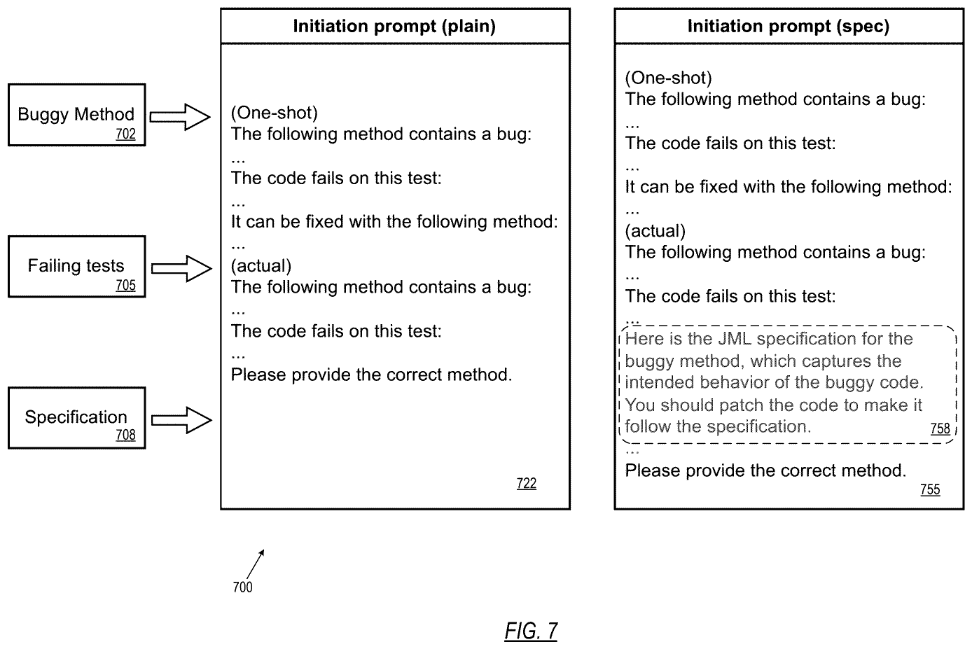

Turning to FIG. 3, the pseudocode (300) implements an algorithm (referred to as “Algorithm 1”) to generate a specification that captures the intended behavior of buggy code. The pseudocode (300) may be converted to source code that may be compiled and executed to perform Algorithm 1. The pseudocode (300) at line 1 identifies the following inputs: a buggy codebase (C), one or more failing tests (T), the buggy method name (buggyName), as well as a configurable maximum iteration number (MAX_ITER). The output is the specification (S). The buggy method to be fixed may be provided by a manual or automated process. The algorithm first identifies the names of the methods that are called by the buggy method (outlined in the RETRIEVECALLEEMETHODS procedure in the pseudocode (300) at lines 3 to 12). The RETRIEVECALLEEMETHODS procedure invokes a tool that performs static code analysis (e.g., Javassist) to statically obtain (i.e., without running the source code) callee methods to the buggy method, which are also defined in the target project codebase. The callee methods, together with the buggy method, are used to form the context for generating the initial specification. Specifications for the callee methods may also be generated so that the verification tool may be run on the buggy method.

With the initial specification generated by a language model, Algorithm 1 enters a specification refinement loop. The refinement loop is at lines 19 through 28 of the SPECIFICATIONGENERATION procedure, which is at lines 13 through 30 of the pseudocode (300). During the refinement loop, the current specification is first verified by running the specification against the buggy codebase using a verification engine. The verification may fail due to two reasons: (1) the specification includes syntactic or semantic errors, or (2) the specification correctly captures the intended behavior of the buggy code so the verification engine reports errors. An example of a verification includes OpenJML. In the refinement loop, the language model is instructed to examine the verification output and improve the specification from the previous iteration with respect to the first type of error (i.e., that the specification itself is incorrect). If the language model determines that the verification engine has verified the specification, or the maximum iteration limit is reached, the algorithm terminates and returns the most recently generated specification.

Turning to FIG. 4, the workflow (400) generates and refines specifications using the specification generation prompt (415) and the specification refinement prompt (425). The inputs include the codebase (402), the buggy method (405), and the failing tests (408). The codebase (402) includes buggy code, which includes the buggy method (405). The buggy method (405) is a method in the codebase (402) with a bug. The failing tests (408) is a set of one or more tests that fail when executed with the buggy method (405).

The static analysis (410) processes the codebase (402) and the buggy method (405) to identify the callee methods (412). The callee methods (412) are methods in the codebase (402) that are called during execution of the buggy method (405).

The callee methods (412), the buggy method (405), and the failing tests (408) are incorporated into the specification generation prompt (415). The specification generation prompt (415) is processed with a language model to generate the specifications (418). The codebase (402) may include multiple buggy methods and each buggy methods may have a separate specification generation prompt generated and processed to form one of the specifications (418).

The specifications (418) are processed by the verification block (420) to generate the verification output (422). The efficiency output (422) is incorporated into the specification refinement prompt (425). The specification refinement prompt (425) may be an updated version of the specification generation prompt (415). The specification refinement prompt (425) may also include one of the specifications, (418) as well as one or more sections from the specification generation prompt (415). The specification refinement prompt (425) is processed with a language model to generate a specification that is a refined version of one of the specifications (418).

At block (428), a determination is made as to whether to identify a refined specification (generated responsive to the specification refinement prompt (425)) as the final specification (430). A refined specification may be identified as the final specification (430) when the refined specification does not include syntax or semantic errors. The final specification (430) is the specification used to generate candidate patches for the buggy method (405).

Turning to FIG. 5, examples from a process of generating and refining specifications are shown. The listing 1 (500) shows an example specification initially generated by the language model, at line 17 of the pseudocode (300) for Algorithm 1 of FIG. 3. After running a verification tool with the initial specification of the listing 1 (500), the verification tool outputs the error shown in the listing 2 (522). The errors indicate that the variable sb should not be used in the preconditions and postconditions, since the variable sb is a local variable. In addition, the pw variable should not appear in the assigns clause since the pw variable is a formal parameter. During the specification refinement process, the language model is provided with the current specification and the verification errors, and eventually refined to form the specification shown in the listing 3 (555).

Turning to FIG. 6, the pseudocode (600) implements an algorithm (referred to as “Algorithm 2”) to generate patches that repair buggy code. The pseudocode (600) may be converted to source code that may be compiled and executed to perform Algorithm 2. The pseudocode (600) at line 33 and onwards in Algorithm 2 describe steps that utilize the procedures defined at lines 3 to 32 of the pseudocode (600). Initially, plausible patches are generated using a loop (e.g., the loop of lines 33 to 39 of the pseudocode (600)) that repeatedly samples candidate patches from the language model and uses the language model to refine the candidate patches. In each iteration of the loop, the candidate patch sampling is done in the PLAUSIBLEPATCHSEARCH procedure defined at lines 3 through 8 of the pseudocode (600).

In the PLAUSIBLEPATCHSEARCH procedure, the algorithm collects a one-shot example of buggy and repaired code pairs to illustrate the expected format of the output from the language model, and instructs the language model to generate candidate patches based on the test failure. With a set of candidate patches generated from the PLAUSIBLEPATCHSEARCH procedure, the PARTIALPATCHIMPROVEMENT procedure executes the existing failing tests on the candidate patches, and instructs the language model to improve the candidate patches if the candidate patches do not pass the failing tests. If plausible patches can be found (i.e., candidate patches that pass the failing tests), the second stage of Algorithm 2 (Line 40) executes to find more plausible patches using the PATCHMULTIPLICATION procedure at lines 24 to 32 of the pseudocode (600).

In the PATCHMULTIPLICATION procedure, the current set of plausible patches are expanded by instructing the language model to generate more diverse patches based on the current plausible patches. As noted above, plausible patches refer to candidate patches that successfully fix the program defined in the buggy code to make the failing tests pass.

An improvement is the addition of using the specification in the PLAUSIBLEPATCHSEARCH procedure in the process of generating candidate patches. In addition to instructing the language model to generate candidate patches, the auto-generated specification from Algorithm 1 is included when constructing the repairPrompt in PLAUSIBLEPATCHSEARCH constructed at line 5 and sent to the language model at line 6.

Turning to FIG. 7, the workflow (700) illustrates examples of repair prompts that may be used in the PLAUSIBLEPATCHSEARCH procedure of the pseudocode (600) of FIG. 6, with and without instructions for using a specification. The buggy method (702) and the failing tests (705) are incorporated into the repair prompt (722). The buggy method (702), the failing tests (705), and the specification (708) are incorporated into the repair prompt (755). The repair prompt (722) (“Initiation prompt (plain)”) shows a repair prompt without instructions for using a specification. The repair prompt (755) (“Initiation prompt (spec)”) shows an alternative augmented with the instructions (758) to use the specification (708). The addition of the specification (708) is a formal description of the intended behavior of the program utilizing the buggy method (702) and provides a goal for program repair that is used to guide the language model during patch generation.

Due to the interaction between patch generation (e.g., Algorithm 2 of FIG. 6, which may utilize the repair prompts (722) and (755) of FIG. 7) and specification generation (e.g., Algorithm 1 of FIG. 3), the specification may not be used in each iteration for the generation of candidate patches. For example, at line 5 of Algorithm 2 of FIG. 6, the function “constructRepairPrompt” may ignore “Spec” by removing or not including the instructions to use the specification when generating a candidate patch. The “candidatePatches” on line 34 of Algorithm 2 of FIG. 6 may have patches that are generated with or without the specification. The use or non-use of a specification provides finer control on how the candidate patches are generated and provides greater differentiation between the candidate patches generated. The differentiation is used since the specifications that are generated, while valid, may not be relevant for the repair to be made to the buggy code.

Turning to FIG. 8, the system (800) may generate the candidate repairs (888) from the bug report (802) utilizing specification assisted program repair. The bug report (802) identifies the codebase, the buggy code, failing tests for the buggy code, and the name of a buggy method within the buggy code. The specification generator (822) communicates with the language model (877) using specification generation prompts that include information extracted from the bug report (802) to generate specifications for the buggy code. The specification generator (822) communicates with the specification verifier (855) to verify that the specifications do not include errors (syntax errors, semantic errors, etc.). The specification generator (822) also communicates with the language terminal (877) using repair prompts to generate the candidate pairs (888) responsive to the specifications and to the information from the bug report (802).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 9.1, the computing system (900) may include one or more computer processor(s) (902), non-persistent storage device(s) (904), persistent storage device(s) (906), a communication interface (908) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) (902) may be one or more cores, or micro-cores, of a processor. The computer processor(s) (902) includes one or more processors. The computer processor(s) (902) may include a central processing unit (CPU), a graphics processing unit (GPU), a tensor processing unit (TPU), combinations thereof, etc.

The input device(s) (910) may include a touchscreen, keyboard, mouse, microphone, touchpad, electronic pen, or any other type of input device. The input device(s) (910) may receive inputs from a user that are responsive to data and messages presented by the output device(s) (912). The inputs may include text input, audio input, video input, etc., which may be processed and transmitted by the computing system (900) in accordance with one or more embodiments. The communication interface (908) may include an integrated circuit for connecting the computing system (900) to a network (not shown) (e.g., a local area network (LAN), a wide area network (WAN) such as the Internet, mobile network, or any other type of network) or to another device, such as another computing device, and combinations thereof.

Further, the output device(s) (912) may include a display device, a printer, external storage, or any other output device. One or more of the output device(s) (912) may be the same or different from the input device(s) (910). The input device(s) (910) and output device(s) (912) may be locally or remotely connected to the computer processor(s) (902). Many different types of computing systems exist, and the aforementioned input device(s) (910) and output device(s) (912) may take other forms. The output device(s) (912) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (902), is configured to perform one or more embodiments, which may include transmitting, receiving, presenting, and displaying data and messages described in the other figures of the disclosure.

The computing system (900) in FIG. 9.1 may be connected to, or be a part of, a network. For example, as shown in FIG. 9.2, the network (920) may include multiple nodes (e.g., node X (922) and node Y (924), as well as extant intervening nodes between node X (922) and node Y (924)). Each node may correspond to a computing system, such as the computing system shown in FIG. 9.1, or a group of nodes combined may correspond to the computing system shown in FIG. 9.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922) and node Y (924)) in the network (920) may be configured to provide services for a client device (926). The services may include receiving requests and transmitting responses to the client device (926). For example, the nodes may be part of a cloud computing system. The client device (926) may be a computing system, such as the computing system shown in FIG. 9.1. Further, the client device (926) may include or perform all or a portion of one or more embodiments.

The computing system of FIG. 9.1 may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
processing buggy code to generate a specification from the buggy code using a specification generation prompt;
verifying the specification to generate a verified specification;
injecting the verified specification into a repair prompt; and
generating a candidate patch for a buggy method in the buggy code using the repair prompt.

2. The method of claim 1, wherein processing the buggy code to construct the specification generation prompt further comprises:
retrieving callee methods called by the buggy method in the buggy code; and
constructing the specification generation prompt for the buggy method in the buggy code using the callee methods.

3. The method of claim 1, wherein verifying the specification further comprises refining the specification using a verification output from a verification engine.

4. The method of claim 1, wherein generating the candidate patch further comprises testing the candidate patch with a failing test.

5. The method of claim 1, wherein generating the candidate patch further comprises revising the candidate patch after testing the candidate patch with a failing test.

6. The method of claim 1, wherein generating the candidate patch further comprises constructing a multiplication prompt using the candidate patch.

7. The method of claim 1, wherein generating the candidate patch further comprises multiplying the patch with a multiplication prompt to generate a plurality of candidate patches comprising the candidate patch.

8. The method of claim 1, wherein generating the candidate patch further comprises selecting the candidate patch from a plurality of candidate patches.

9. The method of claim 1, further comprising:
applying the candidate patch to the buggy code to generate patched code.

10. The method of claim 1, further comprising:
deploying patched code generated from the candidate patch to a computing system,
wherein the computing system executes the patched code.

11. A system comprising:
at least one computer processor; and
an application that, when executing on the at least one computer processor, performs operations comprising:
processing buggy code to generate a specification from the buggy code using a specification generation prompt,
verifying the specification to generate a verified specification,
injecting the verified specification into a repair prompt, and
generating a candidate patch for a buggy method in the buggy code using the repair prompt.

12. The system of claim 11, wherein processing the buggy code to construct the specification generation prompt further comprises:
retrieving callee methods called by the buggy method in the buggy code; and
constructing the specification generation prompt for the buggy method in the buggy code using the callee methods.

13. The system of claim 11, wherein verifying the specification further comprises refining the specification using a verification output from a verification engine.

14. The system of claim 11, wherein generating the candidate patch further comprises testing the candidate patch with a failing test.

15. The system of claim 11, wherein generating the candidate patch further comprises revising the candidate patch after testing the candidate patch with a failing test.

16. The system of claim 11, wherein generating the candidate patch further comprises constructing a multiplication prompt using the candidate patch.

17. The system of claim 11, wherein generating the candidate patch further comprises multiplying the patch with a multiplication prompt to generate a plurality of candidate patches comprising the candidate patch.

18. The system of claim 11, wherein generating the candidate patch further comprises selecting the candidate patch from a plurality of candidate patches.

19. The system of claim 11, wherein the application performs operations further comprising applying the candidate patch to the buggy code to generate patched code.

20. A non-transitory computer readable medium comprising instructions executable by at least one computer processor to perform:
processing buggy code to generate a specification from the buggy code using a specification generation prompt;
verifying the specification to generate a verified specification;
injecting the verified specification into a repair prompt; and
generating a candidate patch for a buggy method in the buggy code using the repair prompt.
